(19) United States
(12) Patent Application Publication
(10) Pub. No.: US 2019/0053431 A1
(43) Pub. Date: Feb. 21, 2019

(54) CROP LIFTER ASSEMBLY

(71) Applicant: William GATERMAN, Daytona Beach, FL (US)

(72) Inventor: William GATERMAN, Daytona Beach, FL (US)

(21) Appl. No.: 15/680,814

(22) Filed: Aug. 18, 2017

(51) Int. Cl. A01D 65/02

(52) U.S. Cl. CPC A01D 65/02; A01D 34/04

(57) ABSTRACT

A crop lifter assembly has an adjustment block, and upper leaf affixed to the adjustment block, a lower leaf affixed to the upper leaf, and a lifter having an end affixed to a distal end of the lower leaf The lower leaf has a distal end positioned away from the upper leaf. The lifter extends angularly upwardly from the distal end of the lower leaf. Each of the lower leaf and the upper leaf can have variable thicknesses and lengths so as to allow for adjustability and tenability for the lower leaf and the lifter. The upper leaf has a channel formed on an upper surface thereof. The adjustment block is received within this channel.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to the field of cutting headers as used in agriculture for cutting crops for harvest and the like. In particular, the present invention relates to crop lifters and assemblies associated therewith that are mounted on the headers so as to increase crop gathering and retention in the harvesting machine.

### 2. Description of Related Art Including Information Disclosed Under 37 CFR 1.97 and 37 CFR 1.98

For various reasons, crops sometimes lie so close to the ground it is difficult to cut them with a conventional harvest head. Some crops are inherently short, while others may be taller, but are prone to fall down when they reach maturity. Heavy rain or hail can also cause the crops to be lying close to the ground at harvest time. Also, the crops will have various thicknesses, diameters, and rigidity.

Typically, the knife on cutting headers comprises a knife bar extending along the front lower edge of the header, with a plurality of triangular knife sections attached to the bar such that the apex of the triangle extends forward from the bar. The exposed side edges of the knife sections are sharpened. Guards are attached to the front lower edge of the header and serve to protect the knife sections from breakage when contacting stones and similar obstructions. The guards comprise oriented guard fingers extending forward. The knife moves back-and-forth along the edge of the header in a slot cut laterally through the guard fingers. In addition to protecting the knife, the guard fingers also enable the knife sections to cut the crop. As the knife section moves back-and-forth, it pushes the crop against the sides of those portions of the guard finger that are above and below the slot, thereby shearing the crop stalks.

A conventional knife is a few inches above the ground when the header is in its lowest position, such that very short or downed crop material will pass under the knife and be lost. Various different kinds of “crop lifters”, as they have been known, have been developed over the last century and more. Typically, these crop lifters are attached to the header and/or the forward extending point of the guard finger, and provide an arm of various designs that rides along the ground ahead of the knife. A lifting finger extends at a shallow angle from the front of the arm back and over the knife. As the header moves down the field, the arm rides along the ground and under the downed crop stalks, which are then lifted and pass over the lifting finger to the knife, where they are cut and continue moving into the header from where they can be passed to the harvester, swather table, or the like.

Most commonly in the prior art, the leading end of the lifting finger is generally the leading end of the arm, and is therefore upturned to provide a ski effect and ride over the ground instead of digging in. If small obstructions are encountered, they will not ride over it, but will be required to push it to the side, making them more subject to damage. A problem with conventional lifters of substantially all types is that breakage, bending, and deformation is not uncommon as a result of contact with obstructions or ground variations in the field. Repair of such damage is time-consuming, requiring removal of the bolts or like fasteners attaching the lifter, and repair, if possible, is by straightening with a press, welding, or the like. Often, replacement is necessarily a fairly significant expense.

Generally, cutting headers are used in taller crops as well as on short and downed crops. In such crops, the header is raised a substantial distance above the ground. Often, in such taller crops, however, there will be crop stalks that have fallen over due to insect damage, weather, or the like and are closer to the ground that the desired cutting height. It is problematic to operate conventional crop lifters below the cutting height to lift these down stalks.

Crop lifters interfere somewhat with normal operations of the header when harvesting taller crops with the header raised a substantial distance above the ground. During turns, in particular, because the crop lifters generally extend a considerable distance ahead of the header, some crop stalks are pushed over and not cut. It is common practice, therefore, to remove the crop lifters when using the header on taller crops.

In view of the wide variability and applications of the crop lifters, there is a need to be able to vary the stiffness and spring rate of the crop lifter. For example, a stiffer crop lifter may be required for certain types of crops or expected obstacles. In other circumstances, a more springy crop lifter is required for more easily harvested crops. The additional springiness can facilitate the ability for processing the crops after the crop lifter. Often, persons in the field of agriculture will know the desired springiness of the crop lifter or the desired stiffness of the crop lifter based upon the types of crops that are to be cut and/or the expected obstacles in the field. Unfortunately, crop lifters often provided with a fixed amount of stiffness and spring rate. A variety of spring-type mechanisms have been provided in the prior art in an attempt to deal with these variations in crops and lifting requirements. However, these mechanisms are quite complicated, requiring large number of mechanical components, and are subject to damage or failure. As such, a need has developed so as to provide a crop lifter assembly wherein the spring rate and stiffness of the crop lifter can be easily adapted to the requirements of the field.

In the past, various patents have issued relating to such crop lifting assemblies. For example, an early patent for a crop lifter is found in U.S. Pat. No. 2,141,299, issued on Dec. 27, 1938 to Hume et al. This patent describes a crop lifter having a hollow approximately V-shaped head, a finger bar having a housing fitted over the head and pivotally supported thereon, a spring mounted on the V-shaped head, and a means for anchoring the respective ends of the spring to the head and of the housing. A set bolt is mounted in a wall of the housing for engagement with the head.

U.S. Pat. No. 2,214,965, issued on Sep. 17, 1940 to J. E. Love, describes a crop lifter having a reciprocating sickle and spaced guards. The crop lifter cooperates with the guards. The crop lifter has a V-shaped frame having an upper lifter bar and a lower support bar attached to the underside of a harvesting mechanism. A brace is located between the support and the lifter bars and has means adapted to receive the nose of a guard to position the crop lifter in advance of the harvesting mechanism.

U.S. Pat. No. 3,163,975, issued on Jan. 5, 1965 to A. S. Lightsey, teaches a crop lifter assembly adapted to be rigidly clamped to the sickle bar of a harvesting machine with the forward end of the crop lifter assembly projecting forwardly of the sickle bar so as to elevate foliage of the crop above the sickle knife while its stalk is being severed. The crop lifter assembly has an elongated rigid main body adapted to be clamped against the underside of the sickle bar and a rear end embracing the rear lateral edge of the sickle bar.

U.S. Pat. No. 4,549,390, issued on Oct. 29, 1985 to K. W. McLean, shows a crop lifter for disc mower-conditioners. The disc cutter bar has transversely-spaced rotatable disc cutters to sever standing crop material by an impact action and a rotatable conditioning mechanism mounted rearwardly of the cutter bar to receive and condition severed crop material. Each disc cutter is provided with a crop lifter affixed to the peripheral portion of the disc cutter adjacent each knife in leading relationship thereto. The crop lifter has an inclined ramp operable to lift previously severed crop material away from the corresponding knife before the knife operatively severs the standing crop material to facilitate a feeding of the severed crop into the conditioning mechanism. The top of the crop lifter is positioned in substantially the same plane as the raised central portion of the disc cutter to properly lift the severed crop material toward the conditioning mechanism and for protecting the hardware detachably fastening the corresponding knife to the disc cutter.

U.S. Pat. No. 5,005,346, issued on Apr. 9, 1991 to L. J. Medernach, shows a crop lifter for swathers or combines. The lifter is relatively short and is bolted to the header using one of the bolts attaching the knife guard to the header. The head is floating so that the lifter rides just on the surface and just in front of the guard so that it picks up the crop and lifts them over the knife assembly and onto the header.

U.S. Pat. No. 6,244,026, issued on Jun. 12, 2001 to Minnihan et al., provides a crop lifter mechanism including a lifter arm in the form of an longitudinally elongated panel which has a lifting tip at its leading end. The panel is vertically oriented and has a crop lifting surface extending along its upper edge. A pair of flexible crop lifting wings extend laterally of the panel so as to expand the effective lifting area of the crop lifter. The crop lifting surface has an initially steep incline followed by a shallower incline.

U.S. Pat. No. 6,708,477, issued on Mar. 23, 2004 to Schumacher et al., discloses a crop lifter for reaping systems of harvesting machines. This system has a bed plate with projecting reaping fingers. A support bar has a first end and a second end. The first end attaches on the bed plate. The second end of the support bar is connected to a grain lifter. The holder is attached on the support bar between the first and second ends. A retainer is arranged on the holder. The pin is insertable into the bores. The holder, together with the retainer, are arranged to form a free motion gap. The support bar can approach the reaping finger or its tip. The support bar is rigidly formed, with respect to flexure, in the area between the second end and the holder. The support bar is elastically formed, with respect to flexure, in the area between the holder and the first end.

U.S. Pat. No. 7,520,119, issued on Apr. 21, 2009 to G. A. Yanko, teaches a crop lifting apparatus that includes a finger recess portion configured to receive a forward end of a guard finger and a securing portion adapted for attachment to the cutting header. A ski mounting plate extends rearward and downward from the finger recess portion under an attached guard finger. A ski member is attached at a rear end thereof to a rear end of the ski mounting plate and extends forward under the ski mounting plate. A lifting arm extends rearward from the front end of the ski member back and over a knife of the cutting header when the apparatus is attached to the guard finger. The ski member and the ski mounting plate are configured to flex.

U.S. Pat. No. 8,112,979, issued on Feb. 14, 2012 to Schumacher et al., shows a crop lifter for a mower of a harvesting machine with at least one mowing finger that has a carrier rail and a stock lifter. A first end of the carrier rail can be fixed to the mower. The stock lifter is configured to a second end of the carrier rail. The stock lifter, together with the carrier rail, encloses an acute angle.

It is an object of the present invention to provide a crop lifter assembly that is adaptable to the expected forces placed on the lifter.

It is another object of the present invention to provide a crop lifter assembly that provides for a greater or lower rigidity.

It is another object of the present invention to provide a crop lifter assembly that has an adjustable spring rate.

It is another object of the present invention to provide a crop lifter assembly that allows for greater flexure at the front portion and greater rigidity at the rear portion.

It is another object of the present invention to provide a crop lifter assembly that facilitates assembly.

It is another object of the present invention provide a crop lifter assembly that minimizes material requirements.

It is another object of the present invention to provide a crop lifter assembly that can be quickly modified and changed as the crop conditions would require.

It is another object of the present invention to provide a crop lifter assembly that avoids damage and breakage to the crop lifter assembly.

It is still another object of the present invention to provide a crop lifter assembly that is “tunable” to crop conditions.

It is still another object of the present invention to provide a crop lifter assembly that is able to adjust the crop lifter tip to various heights.

It is still another object of the present invention to provide a crop lifter assembly that accommodates a variety of sickle guard geometries.

It is still a further object of the present invention to provide a crop lifter assembly that has a minimal number of components and, thus, avoids the possibility of breakage and failure.

It is another object of the present invention to provide a crop lifter assembly to provide a spacer which assures that the leaves are arranged flat in the mounting area so as to provide increased rigidity and ease of manufacturing.

These and other objects and advantages of the present invention will become apparent from a reading of the attached specification and appended claims.

### BRIEF SUMMARY OF THE INVENTION

The present invention is a crop lifter assembly that comprises an adjustment block, and upper leaf affixed to the adjustment block, a lower leaf affixed to the upper leaf, and a lifter having an end affixed to a distal end of the lower leaf The lifter extends angularly upwardly from the distal end of the lower leaf. The lower leaf will have a length greater than a length of the upper leaf The lower leaf has, in particular, a curved configuration. The upper leaf has a channel formed at an upper surface thereof. This channel receives the adjustment block therein. The channel is defined by a first wing extending in transverse relation to the upper leaf and a second wing extending in transverse relation to the upper leaf. The second wing is in parallel spaced relation to the first wing. The first and second wings are integrally formed with the upper leaf.

In one embodiment, the upper leaf can have a thickness equal to the thickness of the lower leaf. Alternatively, the upper leaf can have a thickness less than a thickness of the lower leaf Still further, the upper leaf can have a thickness greater than a thickness of the lower leaf An intermediate leaf can be in interposed between the upper leaf and the lower leaf. A support leaf can be positioned below the lower leaf.

A fastener serves to affix the lower leaf and the upper leaf to the adjustment block. The fastener can be a bolt that has a surface bearing against the underside of the lower leaf and a surface received by the adjustment block. A sickle guard is positioned adjacent to the adjustment block. The upper leaf and the lower leaf are affixed to the adjustment block and to the sickle guard. The adjustment block is vertically adjustable so as to raise or lower the lower leaf and the lifter. A spacer is interposed between the sickle guard at least one of the upper and lower leaves. The spacer has a flat lower surface that bears against the leaf and a crowned upper surface that bears against the sickle guard.

The upper leaf and the lower leaf can have a variety of configurations so as to create the “tenability” and adaptability of the crop lifter assembly of the present invention. In general, the lower leaf will have a curved configuration so as to accommodate uneven ground. In one embodiment, the lower leaf has a length greater than a length of the upper leaf. The upper leaf can have a thickness that is either equal to a thickness of the lower leaf or different than a thickness of the lower leaf. The upper leaf can terminate at a forward end of the block or extend beyond the forward end of the block. An intermediate leaf can be interposed between the upper leaf and the lower leaf If desired, a support leaf can be positioned below the lower leaf for added stiffness.

In general, the crop lifter assembly of the present invention includes a minimum of two leaves. The upper leaf has a channel formed on a portion of the leaf which allows for the mounting and alignment of the adjustment block. The adjustment block makes it possible for the crop lifter to be adjusted for various heights of the crop lifter tip as well as to accommodate a variety of sickle guard geometries. The formed channel also provides the required stiffness in the adjustment block mounting area. The upper leaf may or may not extend beyond the forward end of the formed channel portion, depending on the stiffness requirements.

The lower leaf may be flat or have a formed cross-section. The lifter may be fastened permanently or semi-permanently by a variety of means to the distal end of the lower leaf. Other leaves of various lengths, widths, thicknesses, and cross-sections can be mounted between the upper and lower leaves so as to affect the spring rate (constant or variable) and the overall strength of the crop lifter assembly.

Depending on the method of fastening the leaves together, it may or may be possible to tune the spring rate in the field by adding or subtracting leaves. The adjustment block mounting bolt and the main mounting bolt should be sufficient to hold the assembly together without any additional fasteners. This allows for simplified field stiffness adjustments.

The present invention can have design parameters extended beyond bending stiffness so as to include the torsional stiffness of one or more of the leaves. Due to the unevenness of the farmland terrain, twisting may also be addressed through adjustments in the cross-section of each of the leaves by means of extrusion, forming, fabricating, or heat treatment. The configuration of the present invention allows for low-cost and conventional methods of manufacturing while allowing for maximum adjustability of the fitment and performance characteristics.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view showing a prior art crop lifter assembly.

FIG. 2 is a side elevational view showing a first embodiment of the crop lifter assembly of the present invention.

FIG. 3 is a side isolated side elevational view showing the upper leaf of the crop lifter assembly of the present invention.

FIG. 4 is an isolated plan view of the upper leaf of the cross crop lifter assembly of the present invention.

FIG. 5 is an end view of the upper leaf of the crop lifter assembly of the present invention.

FIG. 6 is a side elevational view showing a second embodiment of the crop lifter assembly of the present invention.

FIG. 7 is a side elevational view of a third embodiment of the cross crop lifter assembly of the present invention.

FIG. 8 is a side elevational view of a fourth embodiment of the crop lifter assembly of the present invention.

FIG. 9 is a side elevational view of a fifth embodiment of the crop lifter assembly of the present invention.

FIG. 10 is a side elevational view of a further embodiment of the crop lifter assembly of the present invention showing a support leaf as positioned below the lower leaf.

FIG. 11 is a perspective view of the spacer of the crop lifter assembly of the present invention.

### DETAILED DESCRIPTION OF THE INVENTION

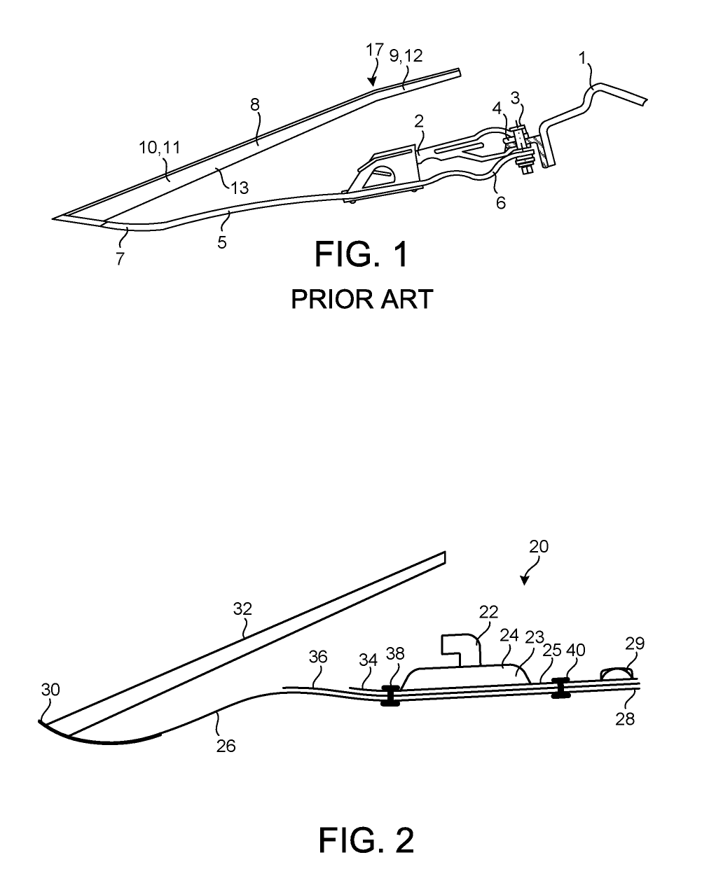

FIG. 1 is a diagrammatic illustration of a crop lifter assembly from the prior art. As can be seen, there is a mower cutter bar 1 with a mowing finger 2 in a projecting position. The mowing finger 2 is fixed by a bolt 3 to the mower bar 1. Several further mowing fingers 2 are associated with the mower bar 2. The fingers 2 are arranged in a distance from each other and project out of and respectively into the drawing plane. The mowing fingers 2 serve to guide a cutter bar and sickle guard 4 that includes mower blades for separating the material to be harvested. The first end 6 of a carrier rail 5 can be fixed to the mower bar 1 via the bolt 3. The carrier rail 5 is preferably produced from a flat material that has bending/elastic properties. The carrier rail 5 is supported on the mowing finger 2 via a fixing mechanism in the form of a holder. The holder is connected to the carrier rail 5 by rivets.

A crop lifter 8 is fixed to the carrier rail 5 at the second end 7 distal from the first end 6. The crop lifter 8 extends at an angle relative to the carrier rail 5 so as to rise towards the mower bar 1. The carrier rail 5 and the crop lifter 8 enclose an acute angle. The carrier rail 5 and the crop lifter 8 can be connected by a weld.

The crop lifter 8 includes a U-shaped profile part 11 and a tubular profile part 12. The crop lifter portion 9 that faces away from the portion fixed with the carrier rail 5 is formed with the tubular profile part 12. The stock portion 10 that faces and is fixed with the carrier rail 5 includes relatively wide arms 13 that are tapered toward the tubular profile part 12. The wide arm 16 at the fixing end provide an advantageous span to achieve a firm welded connection with the carrier rail 5. The U-shaped profile part 11 changes into the tubular part 12 in a transition region in the form of a kink 17. Thus, it encloses an angle that opens toward the carrier rail 5.

One of the problems of the prior art in FIG. 1 is that the carrier rail 5 has a fixed stiffness and spring rate. Since the carrier rail 5 is specifically formed for the purposes of the crop lifter assembly, it has a unique configuration extending from the holder to the lifting bar. In other words, as shown in FIG. 1, the carrier rail 5 has a greater thickness at the lifter 8 than at the holder. This varying thickness is particularly configured to provide the crop lifter with the desired amount of spring rate and stiffness.

Unfortunately, if the carrier rail 5 becomes damaged, it is necessary to find a replacement part. In other circumstances, if different types of crops are encountered, different obstacles are encountered, or other field conditions happen, it is not possible to vary the fixed spring rate and stiffness of the carrier bar 5.

FIG. 2 shows the crop lifter assembly 20 in accordance with the teachings of the present invention. The crop lifter assembly 20 is illustrated with the cutter bar and sickle guard and other associated processing mechanisms associated therewith removed. In all other respects, the crop lifting assembly 20 can be used in association with the various mechanisms of the prior art, such as that shown in FIG. 1.

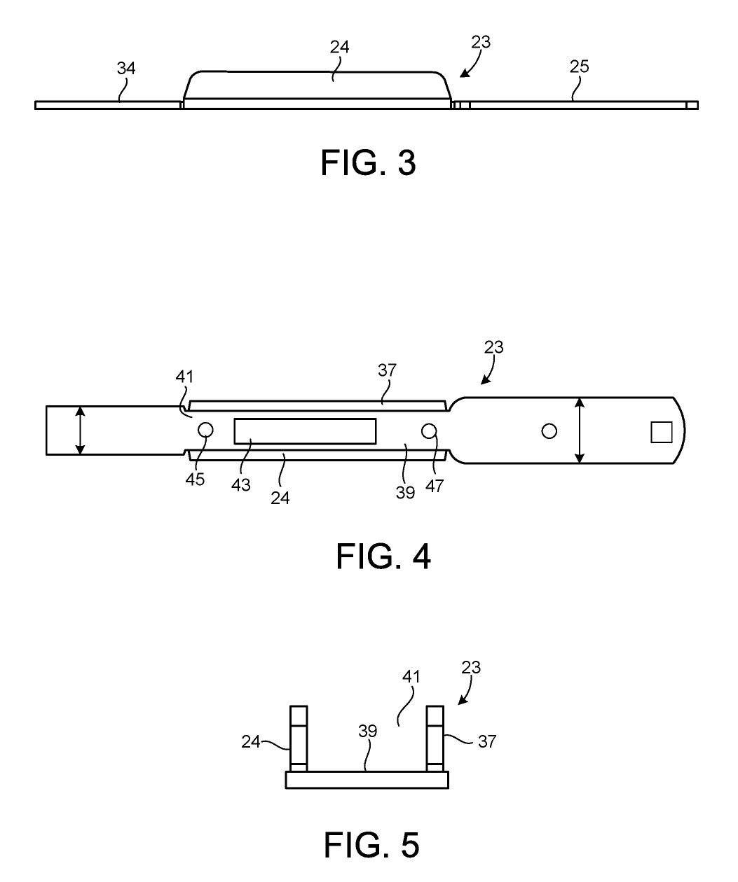

The crop lifter assembly 20 has an adjustment block 22. An upper leaf 23 is affixed to the adjustment block 22. As will be described in the following FIGS. 3-5, the upper leaf 23 is integrally formed from a strip of material so as to have a wing 24 extending upwardly from an elongate surface 34. The adjustment block 22 is received within the channel defined by the wings 24. The elongate portion 34 can extend outwardly of the wings 24 or can terminate at the forward end of the wings. The elongate portion 34 of the upper leaf 23 has an end portion 25 that extends rearwardly of the wings 24.

In FIG. 2, it can be seen that a lower leaf 26 is affixed to the upper leaf 23. The lower leaf 26 has a proximal end 28 at the end of the elongate portion 25 of the upper leaf 23 and secured to the sickle guard. The lower leaf 26 has a distal end 30 away from the forward end 34 of the upper leaf 23. A lifter 32 has an end affixed to the distal end 30 of the lower leaf 26. The lifter 32 extends angularly upwardly from the distal end 30 of the lower leaf The upper leaf 23 extends along a top surface of the lower leaf 26 in the area between the sickle guard and the forward end 34 of the first leaf 23.

FIG. 2 shows that there is a spacer 29 that will be located between the sickle guard (shown in FIG. 1) and the upper leaf 23 and lower leaf 26. The spacer 29 is located at the mounting point of the crop lifter assembly 20 and provides clearance between the underside of the sickle guard and the lower leaf 26. The spacer 29 also allows the upper leaf 23, the lower leaf 26, and any other leaves to be flat in the mounting area. This enhances the ability to manufacture the assembly 20 and also provides increased rigidity to the assembly. The spacer 29 (as shown in FIG. 11) has a flat lower surface 29a and a crowned upper surface 29b. The crowned upper surface 29 will contact the underside of the sickle guard. This allows the crop lifter assembly 20 to have the ability to pivot. As a result, the tip height of the lower leaf 26 can be varied by engaging the sickle guard tip in the various mounting holes of the adjustment block 22. As such, the spacer 29 is a key to the universal fitment, adjustability, and manufacturability of the present invention.

In FIG. 2, there is an intermediate leaf 36 that is positioned between the upper leaf 23 and the lower leaf 26. Within the concept of the present invention, the intermediate leaf 36 may or may not be necessary. The intermediate leaf 36 can extend for a certain length outwardly beyond the forward end 34 of the upper leaf 23 so as to provide additional rigidity to the lower leaf 26. The intermediate leaf 36 will also terminate at the proximal end of the upper leaf 23 at the sickle guard 29.

The adjustment block 22 is affixed to the upper leaf 23, to the intermediate leaf 36 and to the lower leaf 26. As such, the upper leaf 23, the intermediate leaf 36 and the lower leaf 26 can be moved upwardly and downwardly so as to accommodate crop conditions. It can be seen that there is a bolt 38 that secures the lower leaf 26 to the upper leaf 34. Another bolt 40, which is rearward of the wings 24, secures the end portions of the upper leaf 23 and the lower leaf 26 together. Bolts 38 and 40 can also be used to secure the intermediate leaf 36 in a sandwiched condition between the upper leaf 23 and the lower leaf 26.

In FIG. 2, the lower leaf 26 has a substantially greater length than that of the intermediate leaf 36 or the upper leaf 34. In the embodiment shown in FIG. 2, each of the lower leaf 26, the upper leaf 23 and the intermediate leaf 36 will have an approximately equal thickness. It should be noted that, within the concept of the present invention, the forward portion 34 of the upper leaf 23 can be omitted. Additionally, the intermediate leaf 36 can also be omitted if it is desired to have an additional springingness to the lifter bar 32 and the lower leaf 26.

In the embodiment shown in FIG. 2, the use of the lower leaf 26 and the upper leaf 23 allows the operator of the crop lifter assembly 22 to vary the stiffness and/or spring rate of the crop lifter assembly 20. Each of the leaves 26, 36 and 23 can be formed from the same type of material. If greater stiffness is required, then add additional leaves can be utilized in association with the crop lifter assembly 20. If it is desired to add more stiffness, then the bolts 38 and 40 can be removed and an additional leaf or a thicker leaf placed thereon or therein. If it is desired to provide more springingness or less stiffness to the crop lifter assembly 20, then a leaf of lesser thickness can be provided by simply unscrewing the bolts that secures the leaves to the adjustment block 22, removing the leaf, and fastening the bolts back into the position shown in FIG. 2. Bolts or rivets 38 and 40 can be used to secure the leaves together in areas away from the adjustment block 22. All of this can be carried out in a quick, easy and efficient manner with conventional tools.

If the crop lifter assembly is to encounter obstacles or thicker stocks, it would be desirable to increase the stiffness of the crop lifter assembly. As such, the operator of the harvesting machine would add leaves to the assembly or provide thicker leaves in the assembly. The operator can also increase the length of the upper leaves. Specialized forming equipment for the leaves is not required.

FIG. 3 is an isolated view showing the upper leaf 23. As can be seen, the upper leaf 23 has a forward portion 34 and a rearward portion 25. The wing 24 is illustrated as extending upwardly from the upper leaf 23. The forward portion 34 extends outwardly beyond the wing 24. The rearward portion 25 extends rearwardly of the wing 24. The wing 24 is part of a channel, to be described hereinafter. Importantly, the wings 24 can be simply formed by a bending operation on a flat sheet of metal. One of the wings 24 can be bent upwardly so as to reside in transverse relationship with the remainder of the upper leaf 23. Similarly, the other wing can be bent upwardly so as to be in transverse relationship to the remainder of the leaf 23. The wings 24 will be an parallel spaced relation to each other.

FIG. 4 illustrates a plan view of the upper leaf 23. It can be seen that wing 24 is particularly illustrated. Another wing 37 is illustrated as being in parallel spaced relationship to the wing 24. There is a central portion 39 which is located between the wings 24 and 37. Wings 24 and 37 define a channel 41 therebetween. A slot 43 is formed in the central portion 39. Slot 43 can accommodate the adjustment block therein. Similarly, screw holes 45 and 47 are formed through the thickness of the central portion 39 so as to allow for the fastening of the upper leaf 23 to the other leaves.

FIG. 5 is an end view of the upper leaf 23 showing, in particular, the parallel spaced relationship of the wings 24 and 37 and the transverse relationship of the wings 24 and 37 to the central portion 39 of the upper leaf 23. The channel 41 is defined by the wings 24 and 37, along with the central portion 39 serves to receive the adjustment block therein. This configuration provides additional structural integrity to the upper leaf 23 and generally avoids unnecessary flexing in the central area 39.

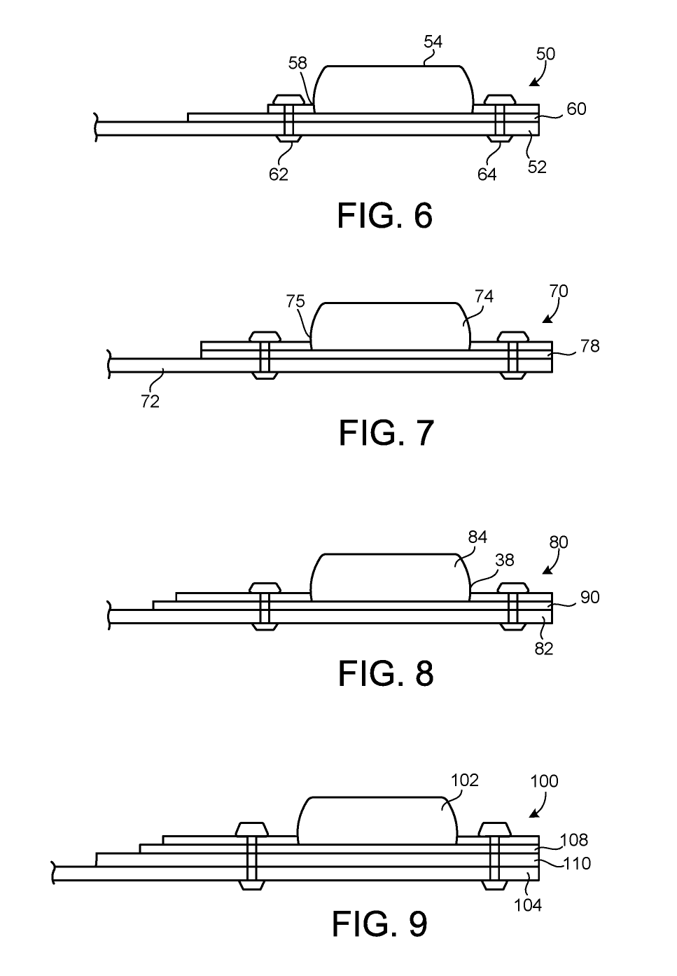

FIG. 6 shows a diagrammatic illustration of an alternative embodiment of the crop lifter assembly 50 of the present invention. In FIG. 3, the crop lifter assembly 50 includes an upper leaf 54 that as a configuration similar to the upper leaf described herein previously. The upper leaf 54 is affixed to a lower leaf 52. An intermediate leaf 60 is interposed between the upper leaf 54 and the lower leaf 52. The lower leaf 52 is illustrated as having a greater thickness than that of the upper leaf 54. The lower leaf 52 also has a greater thickness than the intermediate leaf 60. The greater thickness will impart greater rigidity to the lower leaf 52 in the area toward the distal end of the lower leaf 52. The relatively narrow thickness of the upper leaf 54 and the intermediate leaf 60 will impart comparatively less rigidity in the area of the channel 58. Bolts or rivets 62 and 64 are illustrated as securing the leaves 54, 52 and 60 together. However, the bolts or rivets may not be required

FIG. 7 shows another embodiment of the crop lifter assembly 70. The crop lifter assembly 70 includes an upper leaf 74, a lower leaf 72, and an intermediate leaf 78. The upper leaf 74 terminates at a location forward of the channel 75. The lower leaf 72 will extend outwardly so that the distal end thereof will be engaged with the lifter. The intermediate leaf 78 is interposed between the upper leaf 74 and the lower leaf 72. The intermediate leaf 78 will have an end that extends so as to have a length approximately equal to the length of the upper leaf 74. Each of the leaves 74, 72 and 78 will have an approximately equal thickness. This configuration is adapted to allow less rigidity at the distal end of the lower leaf 76 and providing greater rigidity in the area of the channel 75. Since the leaves 74, 72 and 78 have identical thicknesses, they can be formed from the same sheet of metal material.

FIG. 8 shows the crop lifter assembly 80 in accordance with a further embodiment of the present invention. The crop lifter assembly 80 includes the upper leaf 84, a lower leaf 82 and an intermediate leaf 90. The upper leaf 84 will have a substantially greater thickness than the intermediate leaf 90 or the lower leaf 82. Each of the leaves 84, 82 and 90 will have different lengths with the intermediate leaf 90 being longer than the upper leaf 84 and the lower leaf 82 being longer than the intermediate leaf 90. This configuration would enhance the stiffness of the lower leaf 82 and of the crop lifter assembly 100 in the area of the channel 88 and would provide less rigidity and greater springingness at the distal end of the lower leaf 82.

FIG. 9 shows the crop lifter assembly 100 in accordance with a further embodiment the present invention. The upper leaf 102 is affixed to a pair of intermediate leaves 108 and 110 and to a lower leaf 104. Each of the leaves 102, 108, 110, and 104 have approximately equal thicknesses so that they can be formed from the same sheet of material. In FIG. 9, each of the leaves 102, 108, 110, and 104 have different lengths.

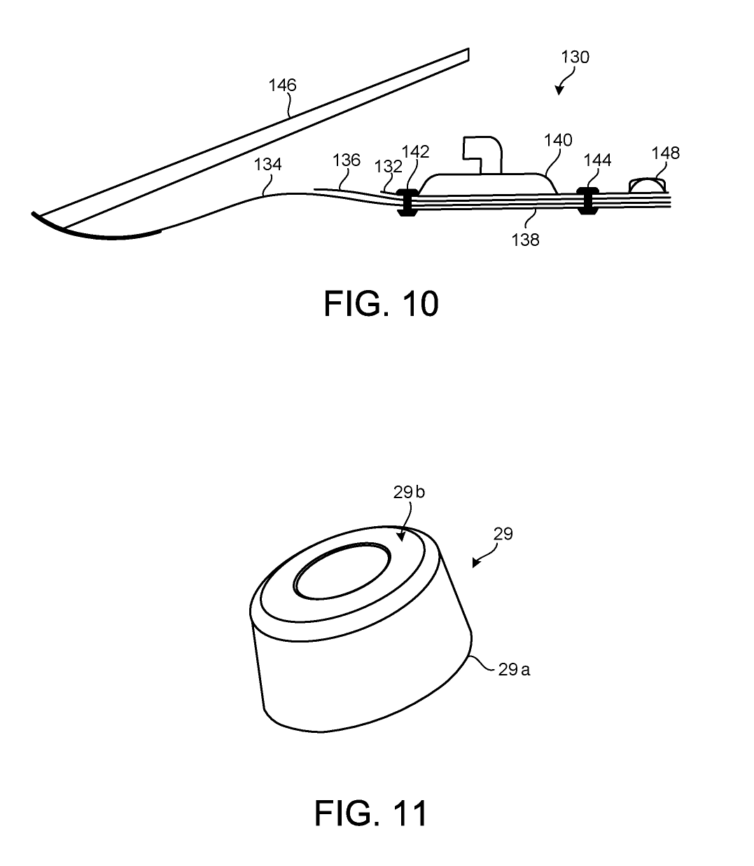

FIG. 10 shows a further embodiment of the crop lifter assembly 130 of the present invention. The crop lifter assembly 130 includes the upper leaf 132, the lower leaf 134, an intermediate leaf 136, and a support leaf 138. The intermediate leaf 136 is interposed between the upper leaf 132 and the lower leaf 134. The intermediate leaf 136 has a length that is greater than the length of the upper leaf 132 and less than the length of the lower leaf 134. The support leaf 134 is secured to the underside of the lower leaf 134 in the area of the adjustment block 140. As such, the support leaf 138 will provide additional stiffness in the area of the mounting with the adjustment block 140. Fasteners 142 and 144 are shown as securing the leaves 132, 134, 136 and 138 together. However, such fasteners may not be required. A main mounting bolt can also be used so as to secure the leaves to the adjustment block 140. The lifter 146 is illustrated as extending upwardly from the outer tip of the lower leaf 134. The spacer 148 is located at the end of the leaves 132, 134, 136 and 138. Spacer 148 will have a configuration similar to that shown in FIG. 11 and as described herein previously.

Within the concept of the present invention, the various leaves can have a variety of thicknesses and/or length depending on the needs for establishing a proper spring rate and stiffness to the crop lifter assembly. Other leaves of various lengths, widths, thicknesses, or cross-sections can be mounted between the upper leaf and the lower leaf so as to affect the spring rate (constant or variable) and the overall strength of the crop lifter assembly. Additionally, if desired, only the upper leaf and the lower leaf would be required. The leaves can be riveted, bolted, welded, or otherwise permanently affixed in place. However, it is believed that the use of the mounting bolts facilitates the ability to adapt the crop lifter assembly to proper field conditions. Additionally, the design parameters can be extended beyond bending stiffness to includes torsional stiffness of one or more of the leaves. This allows for adjustment to the unevenness of farmland terrain. As such, torsional stiffness can be addressed by making adjustments in the cross-section of the leaf by means of extrusion, forming, fabricating or heat treatment.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A crop lifter assembly comprising:
an adjustment block;
an upper leaf affixed to said adjustment block, said upper leaf having a support surface at a bottom thereof;
a lower leaf affixed to said support surface of said upper leaf, said lower leaf having a distal end positioned away from said upper leaf;
a lifter having an end affixed to said distal end of said lower leaf, said lifter extending angularly upwardly from said distal end of said lower leaf.

2. The crop lifter assembly of claim 1, said lower leaf having a length greater than a length of said upper leaf

3. The crop lifter assembly of claim 1, said lower leaf having a curved configuration.

4. The crop lifter assembly of claim 1, said upper leaf having a thickness equal to a thickness of said lower leaf

5. The crop lifter assembly of claim 1, said upper leaf having a channel formed at an upper surface thereof, said channel receiving said adjustment block therein.

6. The crop lifter assembly of claim 5, said channel defined by first wing extending in transverse relation to said upper leaf and a second wing extending in transverse relation to said upper leaf and in parallel spaced relation to said first wing.

7. The crop lifter assembly of claim 6, said first and second wings being integrally formed with said upper leaf.

8. The crop lifter assembly of claim 1, said upper leaf having a thickness that is different than a thickness of said lower leaf.

9. The crop lifter assembly of claim 1, further comprising:
a support leaf positioned below said lower leaf and having a length less than said lower leaf

10. The crop lifter assembly of claim 1, further comprising:
an intermediate leaf interposed between said upper leaf and said lower leaf

11. The crop lifter assembly of claim 1, further comprising:
a fastener affixing said lower leaf and said upper leaf to said adjustment block.

12. The crop lifter assembly of claim 1, further comprising:
a sickle guard docketing for payment adjacent to said adjustment block; and
a spacer interposed between said sickle guard and at least one of said upper and lower leafs.

13. The crop lifter assembly of claim 1, said spacer having a flat lower surface bearing against the leaf and a crowned upper surface bearing against said sickle guard.

14. The crop lifter assembly of claim 1, said adjustment block being vertically adjustable so as to raise or to lower said lower leaf and said lifter.

15. A crop lifter assembly comprising:
an adjustment block;
an upper leaf affixed to said adjustment block, said upper leaf having a channel formed at an upper surface thereof, said channel receiving said adjustment block therein, said upper leaf having a support surface at a bottom thereof;
a lower leaf affixed to said support surface of said upper leaf, said lower leaf having a distal end away from said upper leaf;
a lifter having an end affixed to said distal end of said lower leaf, said lifter extending angularly upwardly from said distal end of said lower leaf; and
a spacer upon at least one of said upper leaf and said lower leaf.

16. The crop lifter assembly of claim 15, said channel defined by a first wing extending in transverse relation to said upper leaf and a second wing extending in transverse relation to said upper leaf and in parallel relation to said first wing.

17. The crop lifter assembly of claim 15, further comprising:
a support leaf positioned at an underside of said lower leaf, said support leaf having a length less than a length of said lower leaf

18. The crop lifter assembly of claim 15, said lower leaf having a thickness equal to a thickness of said upper leaf.

19. The crop lifter assembly of claim 15, said lower leaf having a thickness that is different than a thickness of said upper leaf

20. The crop lifter assembly of claim 15, said upper leaf having a portion extending outwardly of a forward end of said channel.
